(19) United States
(12) Patent Application Publication
(10) Pub. No.: US 2026/0074132 A1
(43) Pub. Date: Mar. 12, 2026

(54) Electric Junction Box

(71) Applicant: Yazaki Corporation, Tokyo (JP)

(72) Inventors: Ryu Senoo, Kakegawa-shi (JP); Kazuyuki Kawashita, Kakegawa-shi (JP)

(21) Appl. No.: 19/389,918

(22) Filed: Nov. 14, 2025

Related U.S. Application Data
(63) Continuation of application No. PCT/JP2023/022098, filed on Jun. 14, 2023.

(51) Int. Cl. H01H 45/04; H01H 45/14; H01H 85/20; H02B 1/01; H02B 1/20

(52) U.S. Cl. CPC H01H 45/04; H01H 45/14; H01H 85/205; H02B 1/01; H02B 1/20

(57) ABSTRACT

An electric junction box includes a pair of relays arranged with a slit in between, a busbar connected to each of the pair of relays, and a case accommodating the pair of relays and the busbar. Each of the pair of relays has a quadrangular shape that has one side face facing the slit and an opposite side face opposite from the one side face when viewed from an accommodation direction of the relays into the case. The busbar has a shape in which the entire busbar is located within a range sandwiched between a straight line obtained by virtually extending the opposite side face of one of the relays and a straight line obtained by virtually extending the opposite side face of another one of the relays when viewed from the accommodation direction.

### CROSS-REFERENCE TO RELATED APPLICATIONS

This is a continuation of International Application No. PCT/JP2023/022098 filed on Jun. 14, 2023, the entire content of which is incorporated herein by reference.

### TECHNICAL FIELD

The present disclosure relates to an electric junction box in which a relay is accommodated in a case.

### BACKGROUND ART

An electric junction box used in an automobile or the like in the related art is configured such that electronic components such as a relay and a fuse are attached to a case made of resin or the like and having a prescribed shape, and input and output terminals of the electronic components are electrically connected to a busbar held in the case, terminals connected to external loads, and the like as disclosed in, for example, JP2005-158479A.

In the electric junction box of the above-described type, a busbar for supplying power to the electronic components such as a relay and a fuse generally extends over the entire case. However, it is considered from a viewpoint of reducing a size of the electric junction box that there is room for improvement in arrangements and structures of the busbar and the electronic components.

An object of the present disclosure is to provide an electric junction box that can have a reduced size.

### SUMMARY OF INVENTION

In one aspect of the present disclosure, an electric junction box includes:
a pair of relays arranged with a slit in between;
a busbar connected to each of the pair of relays; and
a case accommodating the pair of relays and the busbar, in which
each of the pair of relays has a quadrangular shape that has one side face facing the slit and an opposite side face opposite from the one side face when viewed from an accommodation direction of the relays into the case,
the busbar has a shape in which the entire busbar is located within a range sandwiched between a straight line obtained by virtually extending the opposite side face of one of the relays and a straight line obtained by virtually extending the opposite side face of another one of the relays when viewed from the accommodation direction, and
the busbar connected to the one of the relays and the busbar connected to the another one of the relays are independent of each other within the case.

### BRIEF DESCRIPTION OF DRAWINGS

FIG. 1 is a perspective view of an electric junction box according to an embodiment of the present disclosure;

FIG. 2 is a top view of the electric junction box illustrated in FIG. 1;

FIG. 3 is an enlarged view of a portion B in FIG. 2;

FIG. 4 is a bottom view of the electric junction box illustrated in FIG. 1 (only busbars and electronic components (relays and fuses) are illustrated);

FIG. 5 is an enlarged bottom view of a relay 20A illustrated in FIG. 4; and

FIG. 6 illustrates internal circuits of the pair of relays 20A, 20B illustrated in FIG. 4.

### DESCRIPTION OF EMBODIMENTS

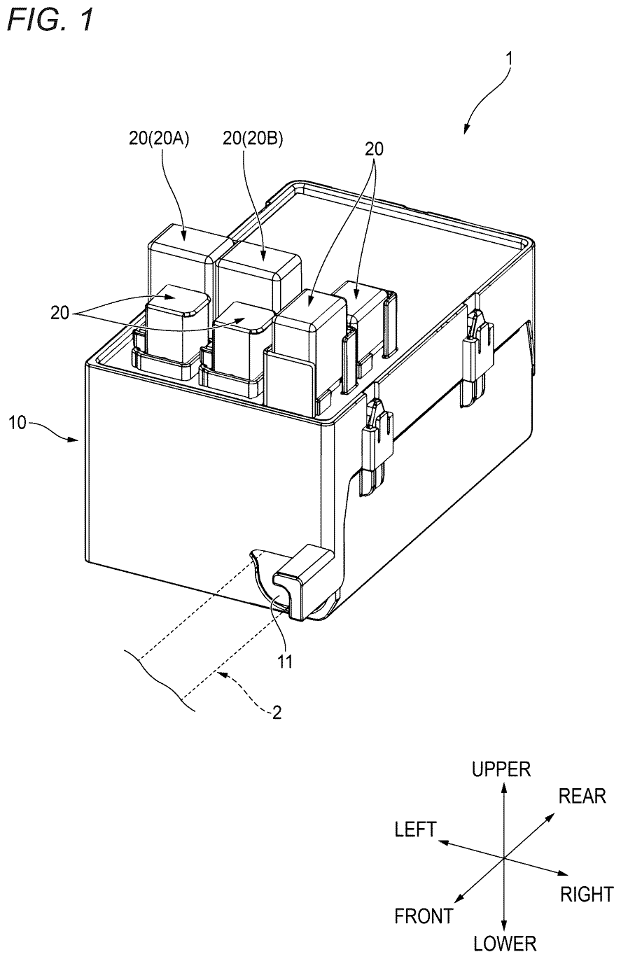

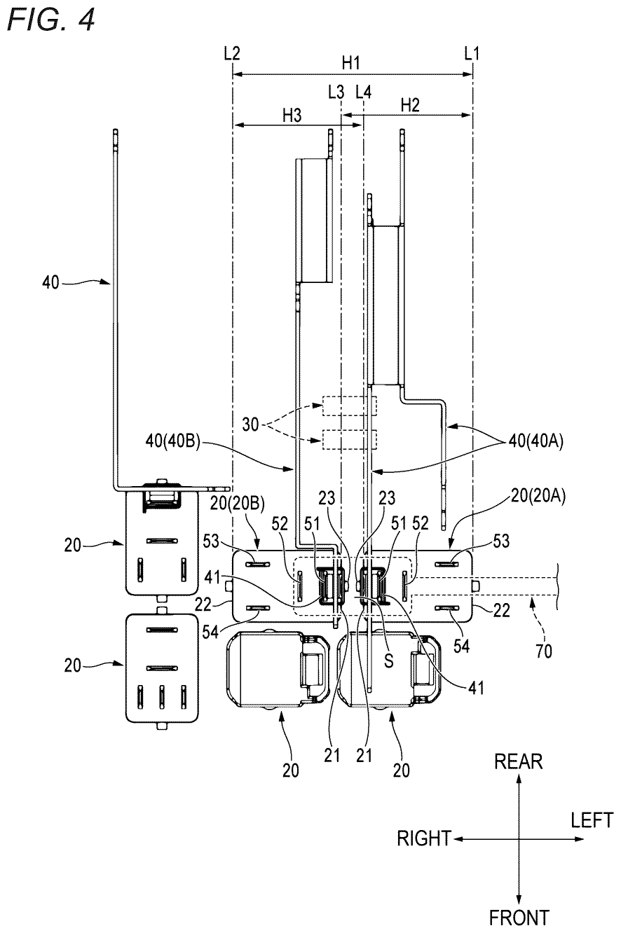

Hereinafter, an electric junction box 1 according to an embodiment of the present disclosure will be described with reference to the drawings. The electric junction box 1 is typically a relay box that is mounted on a vehicle such as an automobile and accommodates electronic components such as relays and fuses. As illustrated in FIGS. 1 to 6, the electric junction box 1 includes a case 10, a plurality of electronic components (specifically, relays 20 and fuses 30 (see FIG. 4)) accommodated in the case 10, and a plurality of busbars 40 (see FIG. 4) held by the case 10.

Hereinafter, for convenience of description, “front”, “rear”, “left”, “right”, “upper”, and “lower” are defined as illustrated in FIG. 1 and the like. A front-rear direction, a left-right direction, and an upper-lower direction are orthogonal to one another. An “upper” side and a “lower” side respectively coincide with an “upper” side and a “lower” side of the vehicle in a state in which the electric junction box 1 is mounted on the vehicle. The upper-lower direction coincides with an “accommodation direction” of the present disclosure. These directions are defined merely for convenience of description, and do not necessarily correspond to a front-rear direction, a left-right direction, and an upper-lower direction of the vehicle when the electric junction box 1 is mounted on the vehicle. Hereinafter, the components constituting the electric junction box 1 will be described in order.

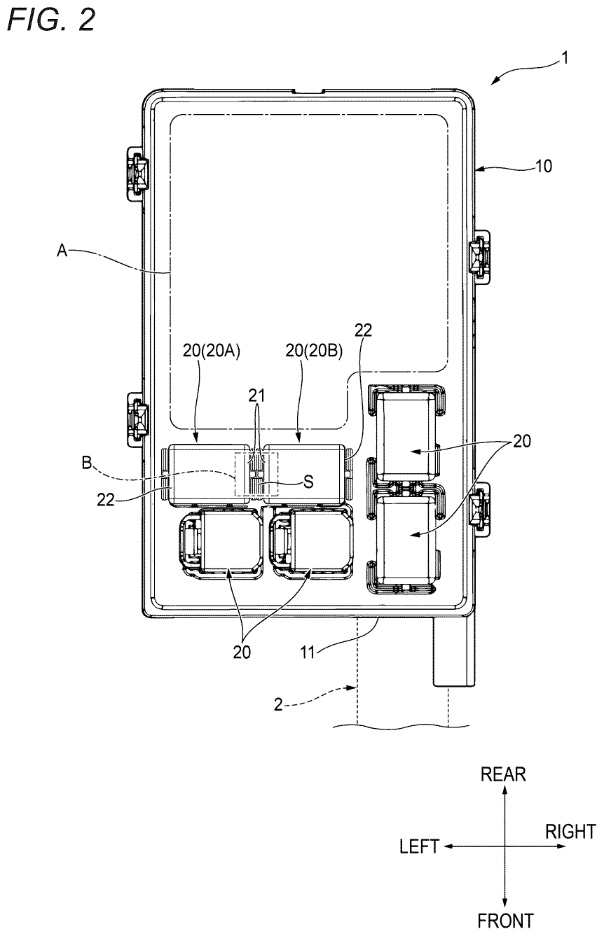

As illustrated in FIGS. 1 and 2, the case 10 is a substantially rectangular parallelepiped resin housing extending in the front-rear direction, the left-right direction, and the upper-lower direction. The case 10 may be formed of a single resin molded body or be formed by combining a plurality of resin molded bodies. In the case 10, a part requiring insulation such as a part holding the electronic components or the busbars 40 may be made of resin, and the other part (for example, an exterior part) may be made of metal.

As illustrated in FIGS. 1 and 2, a plurality of relays 20 are accommodated in a front region of an upper portion of the case 10. Each of the plurality of relays 20 is accommodated in a corresponding accommodation portion (cavity) of the upper portion of the case 10 from the upper side to the lower side. A rear region A (see FIG. 2) adjacent to a rear side of the front region of the upper portion of the case 10 is a region in which the electronic components such as the fuses 30 (see FIG. 4) are accommodated. The fuses 30 and the like are also accommodated in corresponding accommodation portions (cavities) of the upper portion of the case 10 from the upper side to the lower side.

The case 10 is provided with an electric wire insertion portion 11 at a lower right end portion of a front surface thereof (see FIGS. 1 and 2). From the electric wire insertion portion 11, electric wires 2 electrically connected to the busbars 40 and the electric wires 2 electrically connected to the electronic components such as the relays 20 and the fuses 30 extend forward from the inside to the outside of the case 10 (see FIGS. 1 and 2).

As illustrated in FIG. 4, each of the plurality of busbars 40 held by the case 10 is an elongated metal plate having a prescribed shape when viewed in the upper-lower direction. Each of the plurality of busbars 40 is installed and held from the lower side to the upper side at a corresponding prescribed portion of a lower portion of the case 10 such that a plate thickness direction coincides with a direction orthogonal to the upper-lower direction (such that a plate surface faces the direction orthogonal to the upper-lower direction). As a result, each of the plurality of busbars 40 is electrically connected to an input terminal or an output terminal of one or a plurality of corresponding electronic components (relays 20, fuses 30, and the like), so that the plurality of electronic components (relays 20, fuses 30, and the like) are electrically connected to the electric wires 2 (see FIGS. 1 and 2) via the plurality of busbars 40.

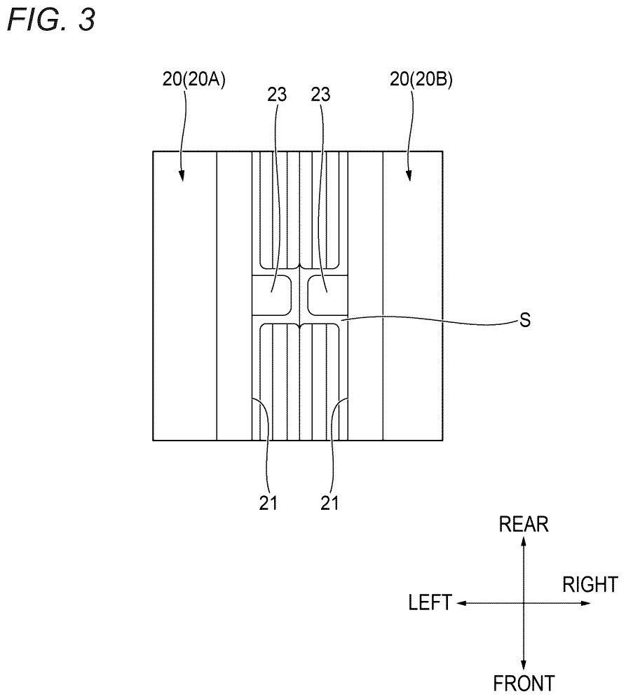

Hereinafter, a pair of relays 20A, 20B (see FIGS. 1 to 5) among the plurality of relays 20 will be focused on. The pair of relays 20A, 20B are relays for a low-voltage circuit in this example, and may also be relays for a high-voltage circuit depending on embodiments. As illustrated in FIGS. 1 to 5, a resin relay body of each of the pair of relays 20A, 20B has a substantially rectangular parallelepiped shape extending in the front-rear direction, the left-right direction, and the upper-lower direction. The relay bodies of the pair of relays 20A, 20B are arranged side by side in the left-right direction with a slit S (see FIGS. 2 to 4) in between in the left-right direction. For this reason, the relay body of each of the pair of relays 20A, 20B has a quadrangular shape that has one side face 21 facing the slit S and an opposite side face 22 opposite from the one side face 21 when viewed from the accommodation direction (upper-lower direction) of the relay 20 into the case 10. The one side face 21 of each of the pair of relays 20A, 20B is provided with a protruding portion 23 protruding toward the slit S (see FIGS. 3 to 5). In the present example, the protruding portions 23 of the pair of relays 20A, 20B are arranged such that protruding ends thereof face each other with a slit in between in the left-right direction.

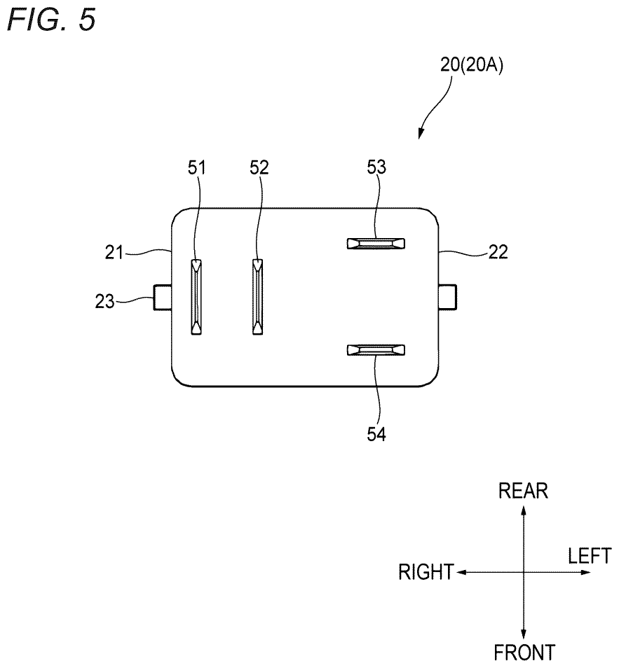

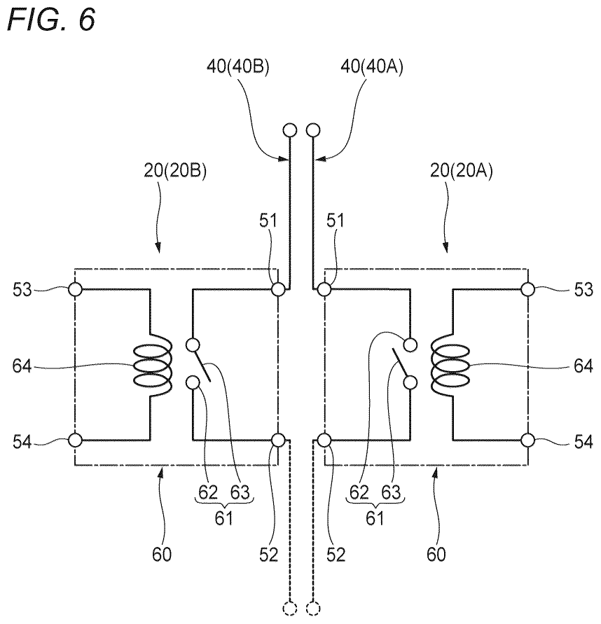

Each of the pair of relays 20A, 20B includes a plurality of terminals 51 to 54 (see FIGS. 4 to 6) connected to an internal circuit 60 (see FIG. 6) provided in the relay body. Each of the plurality of terminals 51 to 54 is a flat plate-shaped (tab-shaped) metal terminal protruding downward from a lower end surface of the relay body of each of the pair of relays 20A, 20B. In the present example, as illustrated in FIGS. 4 and 5, the two terminals 51, 52 face each other with an interval in between in the left-right direction in a region closer to the one side face 21 provided with the protruding portion 23 than to a center of the relay body in the left-right direction. In other words, the protruding portion 23 is disposed in a vicinity of the two terminals 51, 52 of the plurality of terminals 51 to 54. The two terminals 53, 54 face each other with an interval in between in the front-rear direction in a region closer to the opposite side face 22 than to the center of the relay body in the left-right direction.

The terminals 51 of the relays 20A, 20B function as, for example, input-side contact terminals. Specifically, the busbar 40A is connected to the terminal 51 of the relay 20A via a connection terminal 41, and the busbar 40B is connected to the terminal 51 of the relay 20B via the connection terminal 41. Electric wires, which are not illustrated, connected to an external power supply, which is not illustrated, are connected to the busbars 40A, 40B. On the other hand, the terminals 52 of the relays 20A, 20B function as output-side contact terminals, for example. Specifically, electric wires, which are not illustrated, connected to an external load, which is not illustrated, are connected to the terminal 52 of the relay 20A and the terminal 52 of the relay 20B. Each of the busbars 40A, 40B has a shape that has a part bent in a crank shape when viewed in the upper-lower direction and extends substantially in the front-rear direction.

As illustrated in FIG. 6, the internal circuit 60 of each of the pair of relays 20A, 20B includes a switch portion 61. The switch portion 61 includes a fixed contact 62 and a movable contact 63, and is connected to the terminals 51, 52. The switch portion 61 is provided with a biasing member such as a spring which is not illustrated, and the movable contact 63 is biased by the biasing member in a direction away from the fixed contact 62.

The internal circuit 60 includes a coil portion 64 that includes a coil, an iron core which is not illustrated, and the like and functions as an electromagnet. The coil portion 64 is connected to the terminals 53, 54. The terminals 53, 54 function as coil terminals. The coil portion 64 generates a magnetic force when being supplied with a control current via the terminals 53, 54, and attracts the movable contact 63 against a biasing force of the biasing member by the magnetic force. Accordingly, when the coil portion 64 is supplied with a current, the movable contact 63 in the switch portion 61 comes into contact with the fixed contact 62, and the switch portion 61 is in a closed state (ON). Conversely, when the coil portion 64 is not supplied with a current, in the switch portion 61, the movable contact 63 is separated from the fixed contact 62, and the switch portion 61 is in an open state (OFF).

Operation of the pair of relays 20A, 20B is controlled by, for example, an electronic control unit (ECU) which is not illustrated. When the control current is supplied from the ECU to the coil portion 64 of the relay 20A via the terminals 53, 54 and the switch portion 61 of the relay 20A is in the closed state, power from an external power supply is supplied to an external load via the relay 20A. When the control current is supplied to the coil portion 64 of the relay 20B via the terminals 53, 54 and the switch portion 61 of the relay 20B is in the closed state, power from the external power supply is supplied to the external load via the relay 20B.

In the electric junction box 1 described above, as illustrated in FIG. 4, each of the busbar 40A connected to the terminal 51 of the relay 20A and the busbar 40B connected to the terminal 51 of the relay 20B has a shape in which the entire busbars 40A, 40B are located within a range H1 in the left-right direction sandwiched between a straight line L1, which extends in the front-rear direction and is obtained by virtually extending the opposite side face 22 of the relay 20A, and a straight line L2, which extends in the front-rear direction and is obtained by virtually extending the opposite side face 22 of the relay 20B, when viewed from the accommodation direction (upper-lower direction) of the relays 20 into the case 10. In other words, the busbars 40A, 40B fall within a minimum width (that is, inside the range H1) in the left-right direction required for the case 10 to accommodate the pair of relays 20A, 20B.

Arrangements of the electronic components (fuses 30 and the like) different from the relays 20 are designed based on the arrangements of the busbars 40A, 40B within the range H1. In the example illustrated in FIG. 4, arrangements of the two fuses 30 are designed such that the two fuses 30 are connected to the busbar 40A based on the arrangement of the busbar 40A connected to the terminal 51 of the relay 20A. As a result, it is considered that the electric junction box 1 is easy to have a reduced size as a whole as compared with a case where the busbars 40A, 40B are spread over the entire case 10.

Further, the busbar 40A connected to the relay 20A has a shape in which the entire busbar 40A is located within a range H2 sandwiched between the straight line L1, which extends in the front-rear direction and is obtained by virtually extending the opposite side face 22 of the relay 20A, and a straight line L3, which extends in the front-rear direction and is obtained by virtually extending the one side face 21 of the relay 20B, when viewed from the accommodation direction (upper-lower direction) of the relay 20. In other words, the busbar 40A falls within the range H2 narrower than the range H1.

Similarly, the busbar 40B connected to the relay 20B has a shape in which the entire busbar 40B is located within a range H3 sandwiched between the straight line L2, which extends in the front-rear direction and is obtained by virtually extending the opposite side face 22 of the relay 20B, and a straight line L4, which extends in the front-rear direction and is obtained by virtually extending the one side face 21 of the relay 20A, when viewed from the accommodation direction (upper-lower direction) of the relay 20. In other words, the busbar 40B falls within the range H3 narrower than the range H1.

In this manner, it is considered that the size of the electric junction box 1 can be further reduced by further specifying the arrangements of the busbars 40A, 40B to fall within the range H2 and the range H3.

Further, the busbars 40A, 40B are connected to the power input terminals 51 of the relays 20A, 20B, respectively. Accordingly, the electric junction box 1 can have a reduced size even when the large and thick busbars 40A, 40B are adopted to use the terminals 51 for inputting power to the relays 20A, 20B.

Further, the busbar 40A connected to the relay 20A has a shape in which the entire busbar 40A is located within a range H2 sandwiched between the straight line L1, which extends in the front-rear direction and is obtained by virtually extending the opposite side face 22 of the relay 20A, and a straight line L3, which extends in the front-rear direction and is obtained by virtually extending the one side face 21 of the relay 20B, when viewed from the accommodation direction (upper-lower direction) of the relay 20. In other words, the busbar 40A falls within the range H2 narrower than the range H1. Similarly, the busbar 40B connected to the relay 20B has a shape in which the entire busbar 40B is located within a range H3 sandwiched between the straight line L2, which extends in the front-rear direction and is obtained by virtually extending the opposite side face 22 of the relay 20B, and a straight line L4, which extends in the front-rear direction and is obtained by virtually extending the one side face 21 of the relay 20A, when viewed from the accommodation direction (upper-lower direction) of the relay 20. In other words, the busbar 40B falls within the range H3 narrower than the range H1. Accordingly, it is considered that the size of the electric junction box 1 can be further reduced by further specifying the arrangements of the busbars 40A, 40B.

Meanwhile, from a viewpoint different from the above-described reduced size, each of the pair of relays 20A, 20B accommodated in the case 10 includes the protruding portion 23 protruding toward the slit S between the relays 20A, 20B. With the protruding portions 23, the pair of relays 20A, 20B are not disposed excessively close to each other, and the appropriate slit S is present between the pair of relays 20A, 20B. Further, the protruding portion 23 is disposed in the vicinity of the two terminals 51, 52 of each of the pair of relays 20A, 20B. Since the slit S is present between the pair of relays 20A, 20B, Joule heat generated in each of the terminals 51, 52 of the relays 20A, 20B is not concentrated in an excessively narrow range, and heat dissipation is promoted by the flow of air through the slit S. Therefore, the electric junction box 1 has excellent heat dissipation from the relays 20A, 20B accommodated in the case 10. In addition, as compared with a case where heat generated in each of the terminals 51, 52 is dissipated to different portions, the heat generated in each of the terminals 51, 52 is collectively dissipated to the slit S, which can also contribute to a reduced size of the electric junction box 1.

Further, the pair of relays 20A, 20B are arranged such that the protruding portion 23 of the relay 20A and the protruding portion 23 of the relay 20B are not in contact with each other. Accordingly, the slit between the pair of relays 20A, 20B can be widened as compared with a case where the protruding portions 23 are in contact with each other.

Further, the protruding portion 23 of the relay 20A is not in contact with the relay 20B, and the protruding portion 23 of the relay 20B is not in contact with the relay 20A. Accordingly, the slit S between the pair of relays 20A, 20B can be widened as compared with a case where each of the protruding portions 23 is in contact with the counterpart relay 20.

Further, the protruding portion 23 is disposed in the vicinity of two terminals 51, 52 among the plurality of terminals 51 to 54. Accordingly, Joule heat generated in the two terminals 51, 52 of each of the relays 20A, 20B can be appropriately dissipated.

Further, the protruding end (right end) of the protruding portion 23 of the relay 20A is closer to the relay 20B than to the terminal 51 of the relay 20A, and the protruding end (left end) of the protruding portion 23 of the relay 20B is closer to the relay 20A than to the terminal 51 of the relay 20B. Accordingly, the terminal 51 of the relay 20A can be reliably disposed in a position away from the relay 20B, and the terminal 51 of the relay 20B can be reliably disposed in a position away from the relay 20A. Therefore, Joule heat generated in the terminals 51 can be appropriately dissipated.

Further, the protruding portion 23 is provided on the one side face 21 of the relay body of each of the relays 20A, 20B which faces the slit S. Accordingly, a shape of the protruding portion 23 can be simplified as compared with a case where the protruding portion 23 protrudes toward the slit S from the other side face of the relay body. Therefore, manufacturing costs of the relay 20 can be reduced.

Further, the electric junction box 1 may be provided with, as indicated by a broken line in FIG. 4, a heat transfer member 70 that absorbs heat released from at least one terminal (terminals 51, 52 in FIG. 4) of the terminals 51 to 54 of the pair of relays 20A, 20B and transfers the heat in a direction away from the terminal. The heat transfer member 70 is formed of, for example, a metal plate, and extends from the vicinity of the terminals 51, 52 toward the outside of the case 10. The heat transfer member 70 is also referred to as a heat dissipation component. Accordingly, the heat dissipation from the relays 20A, 20B accommodated in the case 10 can be further improved.

The present disclosure is not limited to the embodiment described above, and various modifications can be adopted within the scope of the present disclosure. For example, the present disclosure is not limited to the embodiment described above, and modifications, improvements, and the like can be appropriately made. In addition, materials, shapes, sizes, numbers, arrangement positions, and the like of components in the embodiment described above are freely selected and are not limited as long as the present disclosure can be implemented.

Here, in the above-described embodiment of the present disclosure, an electric junction box (1) includes:
a pair of relays (20A, 20B) arranged with a slit(S) in between;
a busbar (40A, 40B) connected to each of the pair of relays (20A, 20B); and
a case (10) accommodating the pair of relays (20A, 20B) and the busbar (40A, 40B), in which
each of the pair of relays (20A, 20B) has a quadrangular shape that has one side face (21) facing the slit(S) and an opposite side face (22) opposite from the one side face (21) when viewed from an accommodation direction of the relays (20A, 20B) into the case (10),
the busbar (40A, 40B) has a shape in which the entire busbar (40A, 40B) is located within a range (H1) sandwiched between a straight line (L1) obtained by virtually extending the opposite side face (22) of one (20A) of the relays and a straight line (L2) obtained by virtually extending the opposite side face (22) of the other one (20B) of the relays when viewed from the accommodation direction, and
the busbar (40A) connected to the one of the relays (20A) and the busbar (40B) connected to the another one of the relays (20B) are independent of each other within the case (10).

According to the electric junction box having the above configuration, each of the pair of relays has a quadrangular shape that has one side face facing the slit between the relays and an opposite side face opposite from the one side face when viewed from the accommodation direction (for example, upper-lower direction) of the relays into the case. Further, the busbar accommodated in the case has a shape in which the entire busbar is located within a range sandwiched between a straight line obtained by virtually extending the opposite side face of one of the relays and a straight line obtained by virtually extending the opposite side face of the other one of the relays when viewed from the accommodation direction of the relay. Accordingly, the busbar falls within a minimum width (that is, within the above-described range) required for the case to accommodate the pair of relays. Arrangements of other electronic components (for example, fuses) are designed based on an arrangement of the busbar. As a result, it is considered that the electric junction box is easy to have a reduced size as a whole as compared with a case where the busbar is spread over the entire case without limiting the arrangement of the busbar as in the present configuration. Therefore, the electric junction box having this configuration can have a reduced size.

Further, each of the pair of relays (20A, 20B) may include an input terminal (51) and an output terminal (52), and
the busbar (40A, 40B) may be connected to at least one (51) of the input terminal (51) and the output terminal (52).

According to the electric junction box having the above configuration, the busbar is connected to at least one of the input terminal and the output terminal of the relay. Accordingly, the electric junction box can have a reduced size even when a large and thick busbar is adopted to use these terminals for input and output of power to and from the relay.

Further, the busbar (40A (40B)) connected to the one relay (20A (20B)) may have a shape in which the entire busbar (40A (40B) is located within a range (H2 (H3)) sandwiched between the straight line (L1) obtained by virtually extending the opposite side face (22) of the one relay (20A (20B)) and a straight line (L3 (L4)) obtained by virtually extending the one side face (21) of the other relay (20B (20A)) when viewed from the accommodation direction.

According to the electric junction box having the above configuration, the busbar connected to the one relay has a shape in which the entire busbar is located within a range sandwiched between the straight line obtained by virtually extending the opposite side face of the one relay and a straight line obtained by virtually extending the one side face of the other relay when viewed from the accommodation direction of the relay. Accordingly, the electric junction box can have a further reduced size by more specifically specifying the arrangement of the busbar within the above-described range.

Further, the electric junction box (1) may further include an electronic component (30) connected to the busbar (40A) connected to the one relay (20A).
In addition, the electronic component may be a fuse (30) different from the relay (20A, 20B).

According to the electric junction box having the above configuration, the electronic component (for example, fuse) connected to the busbar is attached to the electric junction box. Accordingly, the present disclosure can be specifically implemented.

### INDUSTRIAL APPLICABILITY

The electric junction box of the present disclosure can have a reduced size. The present disclosure having this effect can be used, for example, as a relay box mounted on an automobile or the like.

What is claimed is:

1. An electric junction box comprising:
a pair of relays arranged with a slit in between;
a busbar connected to each of the pair of relays; and
a case accommodating the pair of relays and the busbar, wherein
each of the pair of relays has a quadrangular shape that has one side face facing the slit and an opposite side face opposite from the one side face when viewed from an accommodation direction of the relays into the case,
the busbar has a shape in which the entire busbar is located within a range sandwiched between a straight line obtained by virtually extending the opposite side face of one of the relays and a straight line obtained by virtually extending the opposite side face of another one of the relays when viewed from the accommodation direction, and
the busbar connected to the one of the relays and the busbar connected to the another one of the relays are independent of each other within the case.

2. The electric junction box according to claim 1, wherein
each of the pair of relays includes an input terminal and an output terminal, and
the busbar is connected to at least one of the input terminal and the output terminal.

3. The electric junction box according to claim 1, wherein
the busbar connected to the one relay has a shape in which the entire busbar is located within a range sandwiched between the straight line obtained by virtually extending the opposite side face of the one relay and a straight line obtained by virtually extending the one side face of the other relay when viewed from the accommodation direction.

4. The electric junction box according to claim 1, further comprising:
an electronic component connected to the busbar connected to the one relay.

5. The electric junction box according to claim 4, wherein
the electronic component is a fuse different from the relay.
